(19) United States
(12) Patent Application Publication
(10) Pub. No.: US 2015/0013061 A1
(43) Pub. Date: Jan. 15, 2015

(54) Washing Apparatus

(71) Applicant: PARD HARDWARE INDUSTRIAL CO., LTD., Taichung City (TW)

(72) Inventor: Da-Sen LIN, Taichung City (TW)

(73) Assignee: PARD HARDWARE INDUSTRIAL CO., LTD., Taichung City (TW)

(21) Appl. No.: 13/933,501

(22) Filed: Jul. 2, 2013

(51) Int. Cl. E03C 1/182; B01D 21/24

(52) U.S. Cl. CPC E03C 1/182; B01D 21/2488
USPC 4/626; 210/532.1

(57) ABSTRACT

A detergent-recycling apparatus includes two containers. The first container includes two inlet ports, an outlet port and a drain valve. The first inlet port allows pressurized air to travels into the first container. The second inlet port allows detergent and contaminants to travel into the first container. The drain valve releases the contaminants from the first container. The second container includes an inlet port and an outlet port. The inlet port of the second container is connected to the outlet port of the first container to allow the pressurized air to carry the detergent into the second container from the first container while the contaminants deposit in the first container. The outlet port releases the detergent as well as the pressurized air from the second container.

### BACKGROUND OF INVENTION

1. Field of Invention

The present invention relates to a worktable and, more particularly, to a worktable apparatus including a worktable, a washing unit and a detergent-recycling unit.

2. Related Prior Art

As disclosed in U.S. patent application Ser. No. 13/338,118 filed by the present applicant, a worktable apparatus includes a worktable 10, a washing unit 20 and a supporting unit 30. The worktable 10 includes posts 11 and a horizontal board 14 supported on the posts 11. The washing unit 20 includes sink 21, a valve 25 and two containers 60 and 70. The communication of the sink 21 with the container 70 is under control of the valve 25. The supporting unit 30 includes two trails 31, a tray 32 and casters 33. The rails 31 are connected to the worktable 10 under the sink 21. The tray 32 is placed between the rails 31. The casters 33 are divided into two groups. Each group of casters 33 is connected to a corresponding lateral edge of the tray 32 and movably supported on a corresponding rail 31. The containers 60 and 70 are carried on the tray 32. The container 60 is connected to a nozzle 63 placed near the sink 21. Fresh detergent is filled in the container 60.

Pressurized air travels into the container 60 from an air compressor. The pressurized air carries the detergent into the nozzle 63, which is operable to release the detergent for cleaning an article of contaminants. The used detergent and the contaminants travel into the container 70 from the sink 21 through the valve 25. The used detergent and the contaminants are disposed of. In many cases, the used detergent is however reusable. The disposal of the used detergent is a waste.

The present invention is therefore intended to obviate or at least alleviate the problems encountered in prior art.

### SUMMARY OF INVENTION

It is the primary objective of the present invention to provide a worktable apparatus with a detergent-recycling apparatus.

To achieve the foregoing objective, the detergent-recycling apparatus includes two containers. The first container includes two inlet ports, an outlet port and a drain valve. The first inlet port allows pressurized air to travels into the first container. The second inlet port allows detergent and contaminants to travel into the first container. The drain valve releases the contaminants from the first container. The second container includes an inlet port and an outlet port. The inlet port of the second container is connected to the outlet port of the first container to allow the pressurized air to carry the detergent into the second container from the first container while the contaminants deposit in the first container. The outlet port releases the detergent as well as the pressurized air from the second container.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a detergent-recycling unit of a worktable apparatus according to the preferred embodiment of the present invention;

FIG. 2 is a perspective view of the worktable apparatus in another position than shown in FIG. 1;

FIG. 3 is a cross-sectional view of the worktable apparatus of FIG. 2;

FIG. 4 is another cross-sectional view of the worktable apparatus shown in FIG. 3; and

FIG. 5 is a cross-sectional view of the worktable apparatus in another status than shown in FIG. 3.

### DETAILED DESCRIPTION OF PREFERRED EMBODIMENT

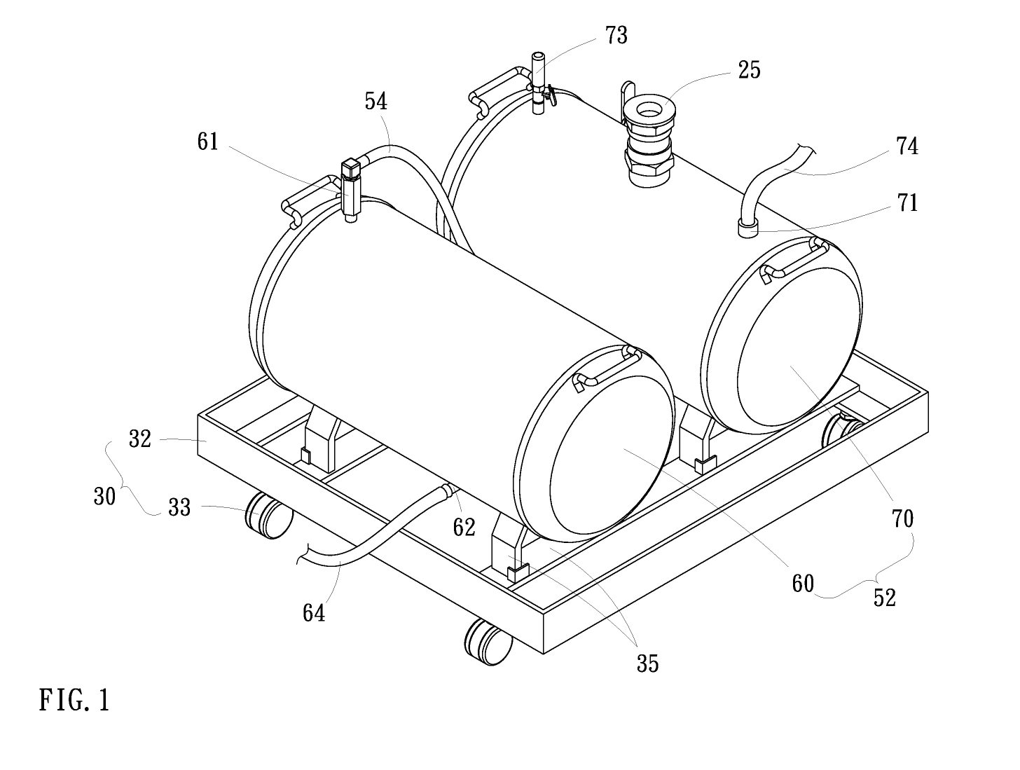

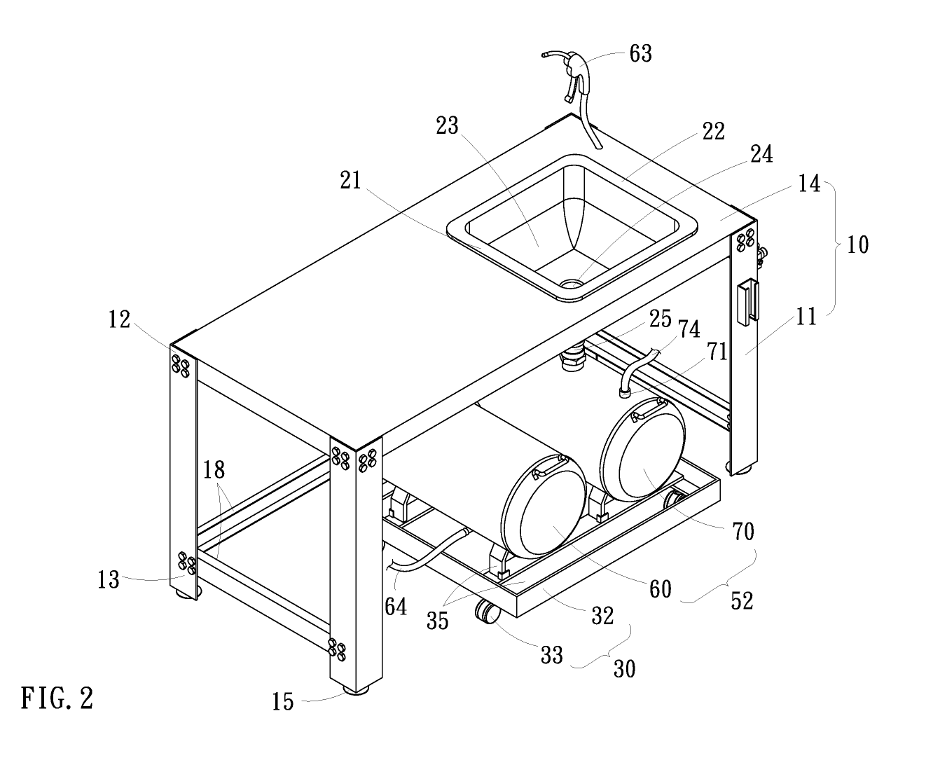

Referring to FIGS. 1 and 2, a worktable apparatus includes a worktable 10, a washing unit, a supporting unit 30 and a detergent-recycling unit 52 in accordance with the preferred embodiment of the present invention.

The worktable 10 includes four posts 11, a horizontal board 14, four elevation adjusters 15, and crossbars 18. Each of the posts 11 includes an upper end 12 connected to the horizontal board 14 and a lower end 13 connected to a corresponding one of the elevation adjusters 15. The elevation adjusters 15 are placed on the ground or a floor. The elevation adjusters 15 can be operated to render the horizontal board 14 horizontal. Each of the crossbars 18 interconnects two adjacent ones of the posts 11 below the horizontal board 14.

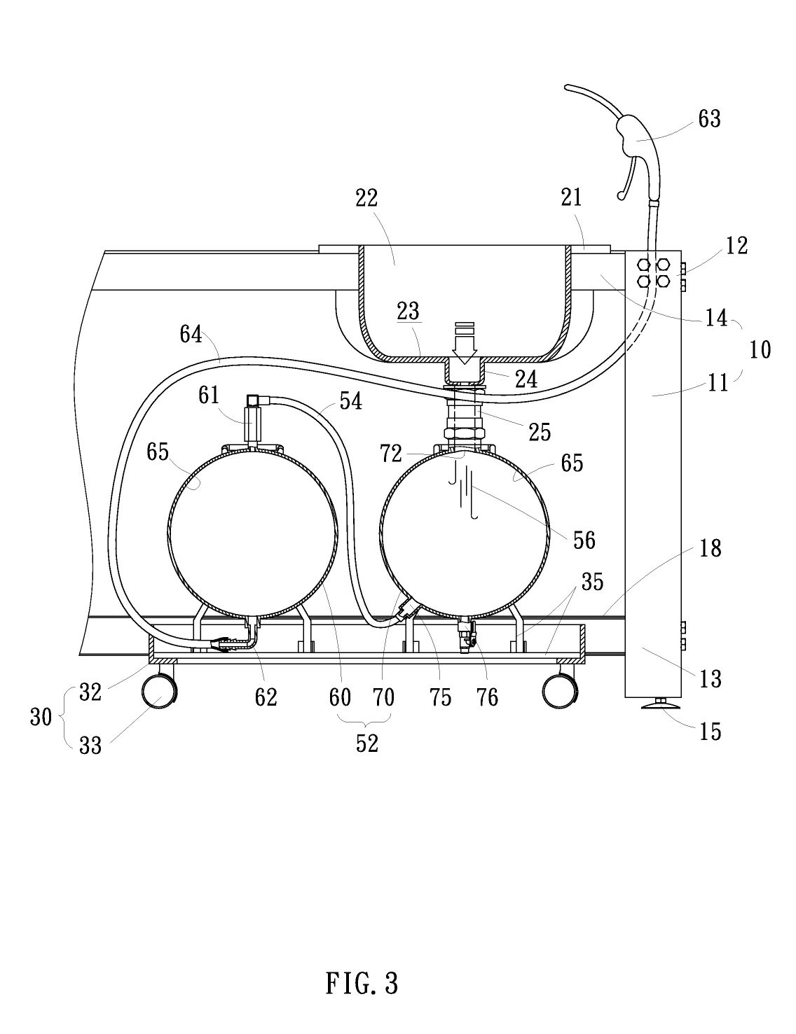

The washing unit includes a sink 21 and a valve 25. The sink 21 includes a wall extending around a bottom plate 23. An opening 22 is defined by the edge of the wall, which is connected to the horizontal board 14 by welding for example. The sink 21 is made with an adequate depth measured from the opening 22 to the bottom plate 23. A drain 24 is defined in the bottom plate 23. As shown in FIG. 3, the valve 25 is connected to a lower face of the bottom plate 23 so that the drain 24 is in communication with and under control of the valve 25.

The supporting unit 30 includes a tray 32 and casters 33. The casters 33 are connected to the tray 32.

The detergent-recycling unit 52 is supported on the tray 32 in use. The detergent-recycling unit 52 includes two containers 70 and 60.

Further referring to FIG. 3, the first container 70 includes two inlet ports 71 and 72, a safety valve 73, an outlet port 75 and a drain valve 76. The first inlet port 71 is connected to an air compressor (not shown) via a pipe 74. The second inlet port 72 is connected to the valve 25. Thus, the first container 70 is in communication with the sink 21.

The second container 60 includes an inlet port 61 and an outlet port 62. The inlet port 61 of the second container 60 is connected to the outlet port 75 of the first container 70 via a pipe 54. Thus, the second container 60 is in communication with the first container 70. The outlet port 62 is connected to a nozzle 63 via a pipe 64. The nozzle 63 is placed near the sink 21, above the horizontal board 14.

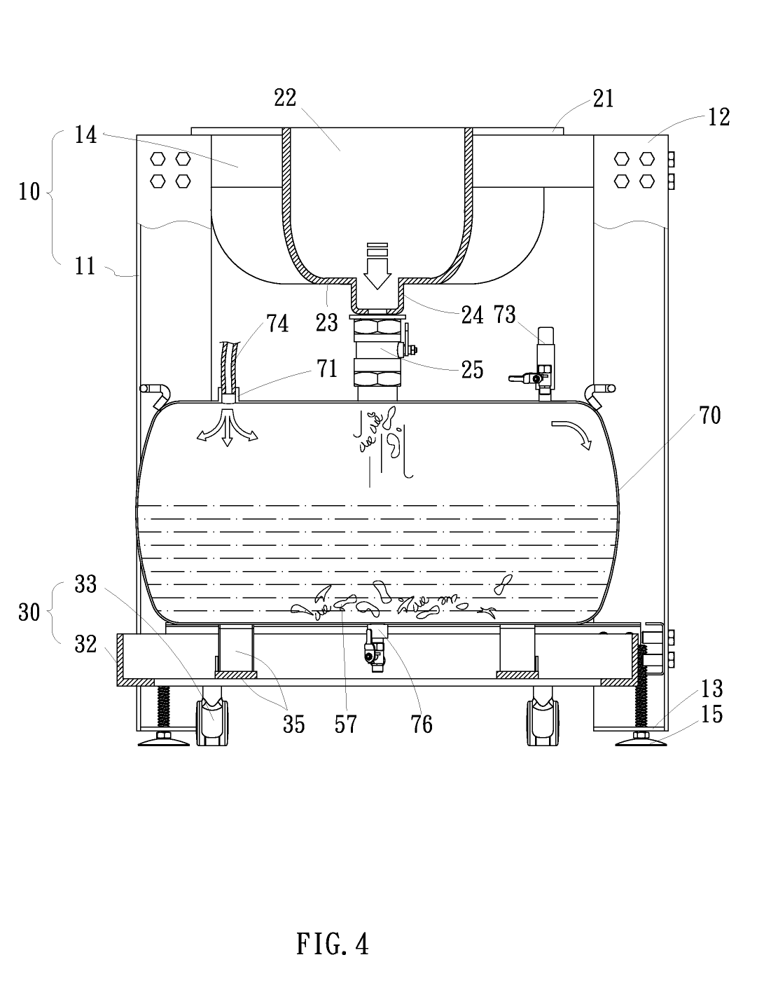

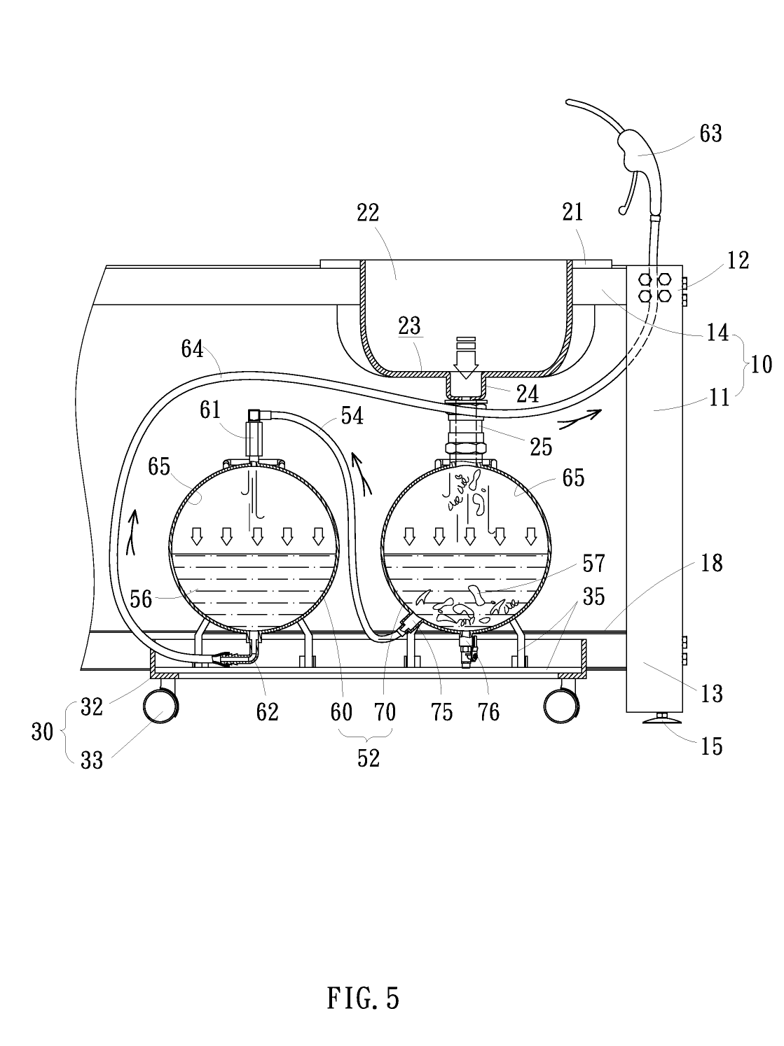

Referring to FIGS. 4 and 5, for a round of washing, the valve 25 is placed in a closed position. Fresh detergent 56 is filled in the second container 60 before the inlet port 61 of the second container 60 is connected to the outlet port 75 of the first container 70 via the pipe 54. The drain valve 76 is placed in a closed position. Pressurized air travels into the first container 70 from the air compressor through the pipe 74. The safety valve 73 releases some of the pressurized air from the first container 70 if the pressure reaches a limit in the first container 70. Then, the pressurized air travels into the second container 60 from the first container 70 through the pipe 54. Then, the pressurized air travels into the nozzle 63 from the second container 60 via the pipe 64. On the way into the nozzle 63 from the second container 60, the pressurized air carries the detergent 56. Finally, the nozzle 63 is operated to release the detergent 56 as well as the pressurized air. The detergent 56 is provided on an article to help clean the article of contaminants. The used detergent 56 and the contaminants are contained in the sink 21 because the valve 25 is in the closed position.

After the round of washing, the valve 25 is turned into an open position to allow the used detergent 56 and the contaminants to travel into the first container 70 from the sink 21. Most of the contaminants deposit in the first container 70 because they cannot be dissolved in the detergent 56 and their densities are larger than that of the detergent 56.

For another round of washing, more pressurized air travels into the first container 70 from the air compressor via the pipe 74. Then, the pressurized air travels into the second container 60 from the first container 70 through the pipe 54. On the way into the second container 60 from the first container 70, the pressurized air carries the recycled detergent while the contaminants deposit in the first container 70. Then, the pressurized air travels into the nozzle 63 from the second container 60 through the pipe 64. On the way into the nozzle 63 from the second container 60, the pressurized air carries the detergent 56, fresh or recycled. Finally, the nozzle 63 is operated to release the detergent 56 as well as the pressurized air. The detergent 56 is provided on another article to help clean the article of contaminants. The used detergent 56 and the contaminants are contained in the sink 21 because the valve 25 is in a closed position.

After the washing, the valve 25 is turned into an open position to allow the used detergent 56 and the contaminants to travel into the first container 70 from the sink 21. The contaminants deposit in the first container 70.

The foregoing process can be repeated for another round of washing. However, the foregoing process must be interrupted when the nozzle 63 undesirably releases the contaminants in addition to the detergent 56. Now, the contaminants must be removed from the first container 70. To this end, the valve 25 is turned to the closed position and the second inlet port 72 of the first container 70 is detached from the valve 25. The drain valve 76 is turned to an open position to release the contaminants from the first container 70.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A detergent-recycling apparatus including:
a first container including:
a first inlet port for allowing pressurized air to travels into the first container;
a second inlet port for allowing detergent and contaminants to travel into the first container; and
an outlet port; and
a second container including:
an inlet port connected to the outlet port of the first container to allow the pressurized air to carry the detergent into the second container from the first container while the contaminants deposit in the first container; and
an outlet port for releasing the detergent as well as the pressurized air from the second container.

2. The detergent-recycling apparatus according to claim 1, wherein the first container includes a drain valve for releasing the contaminants from the first container.

3. The detergent-recycling apparatus according to claim 1, wherein the first container includes a safety valve for releasing some of the pressurized air from the first container if the pressure reaches a limit in the first container.

4. The worktable apparatus according to claim 1, including a pipe for connecting the outlet port of the first container to the inlet port of the second container.

5. A worktable apparatus including the detergent-recycling apparatus according to claim 1.

6. The worktable apparatus according to claim 5, including:
a worktable;
a washing unit including:
a sink supported on the worktable;
a valve for controlling the communication of the sink with the second inlet port of the first container; and
a nozzle connected to the outlet port of the second container; and
a supporting unit including:
a tray for carrying the first and second containers; and
casters connected to the tray.

7. The worktable apparatus according to claim 6, including a pipe for connecting the outlet port to the nozzle.
